(19) United States
(12) Patent Application Publication
(10) Pub. No.: US 2007/0041563 A1
(43) Pub. Date: Feb. 22, 2007

(54) Call centre having operator workstations, a switching device and a call distribution system, and a method of operating a call centre of this kind

(76) Inventors: Christian Maierhofer, Lilienfeld (AT); Bernhard Plakolm, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/453,576

(22) Filed: Jun. 15, 2006

(30) Foreign Application Priority Data
Jun. 16, 2005 (DE) 102005027869.8

(51) Int. Cl. H04M 3/00

(52) U.S. Cl. 379/265.01

(57) ABSTRACT

A call centre in a communications network, having a plurality of operator workstations, a switching device and a call distribution system, and to a method of operating this call centre is provided. In this arrangement, virtual operator workstations are provided in the call centre which, after operator-specific access data has been entered by way of a user traffic connection of the communications network, are each connected to a respective external operator workstation. Calls are then forwarded by way of the virtual operator workstation to the external operator workstation by the call distribution system until the virtual operator workstation in the call centre is released again by the entering of operator-specific data.

### CROSS REFERENCE TO RELATED APPLICATIONS

This application claims priority of German application No. 102005027869.8 DE filed Jun. 16, 2005, which is incorporated by reference herein in its entirety.

### FIELD OF INVENTION

The invention relates to a call centre in a communications network, having a plurality of operator workstations, a switching device and a call distribution system, and to a method of operating this call centre.

### BACKGROUND OF INVENTION

For some years, as companies or organisations become more service-oriented, communications networks have made use of call centres. Call centres of this kind may serve to carry out a wide range of tasks, such as those for information purposes in the form of hot-line services, product information, etc., and for complaints management, telephone marketing, market and opinion research, taking on jobs and orders, sales or for emergency customer service.

In principle, a distinction is made between two types of call centres, namely so-called inbound call centres and so-called outbound call centres, with the inbound call centres only processing incoming telephone calls and the outbound call centres only handling outgoing telephone calls. To improve the utilisation of a call centre, it is also possible to mix these two types of call centres.

To handle incoming and outgoing calls, a plurality of so-called operator workstations are associated with the call centre, and these are usually equipped with telephones, headsets and computer terminals for the staff at the call centre—the so-called operators or agents. Operators meet and deal with the wishes of callers from these operator workstations or, in outbound call centres, they make the calls—primarily for active telemarketing or market and opinion research. In this case, the operator workstations may be accommodated centrally at one location or within so-called corporate networks, which are a communications network within a company or organisation having various geographical locations, or indeed at different locations. The operator workstations may moreover be divided into a plurality of groups, by which different tasks (for example order-taking, complaints, customer information service, etc.) are performed. The calls may be passed on to these operator groups by a so-called computer telephony integration (CTI) system.

The CTI system may be part of the call centre, in which case the term CTI is used to mean the possibility of an interface between the switching device and user programs running on a computer. CTI systems are used to supply the operator, usually by means of the calling number of a caller, with caller-specific data or indeed technical documents at the computer terminal of the operator workstation, or they give the operator the means of controlling the call by way of computer terminal from the operator workstation.

In order to reach the call centre from any telephone line in the communications network, a central dial-in point in the form of a single customer service call number in this communications network is usually provided. The operator workstations are in this case connected to the communications network by way of a switching device, such as a private branch exchange, a switching centre, etc. When a caller in the communications network dials the customer service call number of the call centre, this call is forwarded in the communications network to the switching device of the call centre and is then connected to one of the operator workstations with the aid of a call distribution system.

The call distribution system is either provided as a stand-alone unit in the call centre, between the switching device and the operator workstations, or is integrated in the switching device as a separate component with separate functionality. The call distribution system performs the task of evenly distributing the incoming calls to the available operators. This distribution is typically carried out using the so-called “first in first out” principle and the so-called “longest idle” principle. This means that the first incoming call to be registered in the switching device of the call centre is forwarded to the operator who has not dealt with a call for the longest.

As described in the “Lexikon der Kommunikations—und Informationstechnik [Dictionary of Telecommunications and Information Technology]”, 3^{rd} edition, Heidelberg: Hüthig, 2001, by Niels Kluβmann, the hardware system of a call centre includes, integrated therein, a switching device having a call distribution system, a plurality of operator workstations and a CTI system for the simple handling of, for example, customer data or technical documents. In this arrangement, the interface between the communications network and all the operator workstations of the call centre is formed by the switching device. The operator workstations must in this case be set up at the switching device upstream of which the call distribution function is then taken over, or to which the call distribution system is connected, so that the functionality of the call centre (for example, call distribution, etc.) is ensured. A structure of this kind for a call centre is also referred to as static.

### SUMMARY OF INVENTION

With a static structure of the call centre, however, it is not really possible to connect individually operator workstations which are connected to the communications network by means of different switching devices, such as home workstations or operators with mobile terminals. For operator workstations at a fixed location (such as a home workstation, or operator workstations at geographically different locations in a company or organisation), although it is possible to connect these to the switching device of the call centre by means of a so-called dedicated line, which offers a rented and permanently available, permanently connected transmission capacity to a communications network, this possibility is usually high-cost and associated with a high level of complexity. Connecting mobile operator workstations to the structure of the call centre is, however, not possible at all.

It is therefore an object of the present invention to provide a call centre and a method of operating a call centre through which it becomes possible to connect any number of operator workstations, including mobile ones, in a simple manner which is not location-dependent.

In accordance with the invention, this object is achieved by a call centre which is in a communications network and which comprises a plurality of operator workstations, a switching device and a call distribution system, with virtual operator workstations being provided in the call centre which, after operator-specific access data has been entered by way of a user traffic connection of the communications network, are each connected to a respective external operator workstation and are then available for the forwarding of calls to the external operator workstation by the call distribution system.

The advantages achieved by the invention reside in particular in the fact that external operator workstations can be connected to the call centre in a simple and inexpensive manner with the aid of virtual operator workstations which are set up at the switching device. As a result of entering operator-specific access data, the external operator workstation can be made available for the forwarding of calls made to the call centre, regardless of its geographical location in the communications network.

It is favourable if there are provided as the operator-specific access data an identification of the respective operator, a calling number and a password. This access data can then be used to authenticate the operator, by being sent for example to a corresponding database and thus a check being carried out of whether the operator is entitled to carry out operator activity in the call centre.

It is also recommended that the Internet is provided for entering the operator-specific access data, since this variant on the entering of access data can be implemented in a simple and inexpensive manner and is also not dependent on the geographical location of the operator workstation.

Advantageously, a mobile terminal is to be provided as the external operator workstation, as a result of which the operator activity can be carried out in a simple manner at any geographical location. For this, the operator only needs mobile terminals such as a mobile telephone, a laptop, etc. and access to a communications network.

It is also advantageous if a terminal which is fixedly connected to the communications network is provided as the external operator workstation. In this way, for example, operator workstations at different locations in a company or organisation or home workstations equipped with a fixed-line telephone and an Internet connection can be connected to the structure of the call centre without a high level of complexity.

The object is furthermore achieved by a method of operating a call centre, in which an operator having an external operator workstation enters operator-specific access data and then, on the basis of this data entered, a connection is made by way of a user traffic connection of the communications network between a virtual operator workstation in the call centre and the external operator workstation, and then calls are forwarded by way of the virtual operator workstation to the external operator workstation by the call distribution system until the virtual operator workstation in the call centre is released again by the entering of operator-specific data.

The method according to the invention has the advantage that operators at different geographical locations or having mobile terminals can be connected to the structure of the call centre without a high level of complexity for the period of their operator activity. During the operator activity, the external operator workstation is connected to make it available such that calls can be forwarded to the external operator workstation by way of the virtual operator workstation set up in the switching device, by the criteria of the call distribution system.

It may moreover also be favourable if the user traffic connection of the communications network between the virtual operator workstation and the external operator workstation is made with the aid of call diversion. This call diversion to the external operator workstation may be set up at the virtual operator workstation in a simple manner at the time of authentication of the operator.

In a further advantageous embodiment of the method according to the invention, the information for the user traffic connection of the communications network between the virtual operator workstation and the external operator workstation is determined dynamically. In this case, when the call distribution system forwards a call to a virtual operator workstation, the calling number of the external operator workstation at which a connection has been made by way of a user traffic connection of the communications network with the virtual operator workstation in the call centre is determined for example by interrogation of a database.

### BRIEF DESCRIPTION OF THE DRAWINGS

The invention will be explained below by way of example, with reference to the attached figures, in which:

FIG. 1 shows the functional structure of a communications network having the call centre according to the invention, and the schematic sequence of connecting an external operator workstation to the call centre according to the invention,

FIG. 2 shows the schematic sequence of making a connection between a subscriber to the communications network and an external operator workstation, using to the call centre according to the invention, and

FIG. 3 shows the schematic sequence of cancelling the connection between the call centre according to the invention and the external operator workstation.

### DETAILED DESCRIPTION OF INVENTION

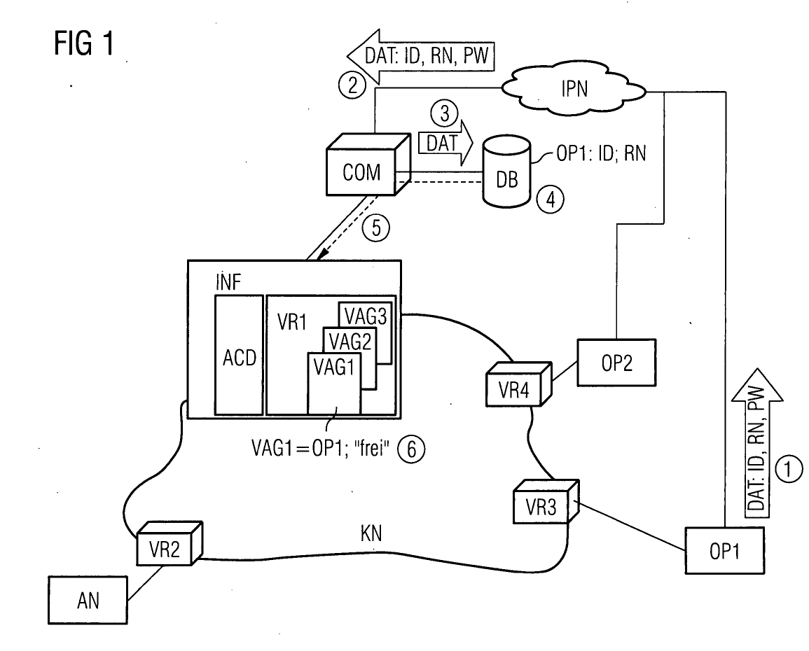

FIG. 1 shows, by way of example, a communications network KN having a plurality of switching devices VR1, VR2 and VR3, in which the switching device VR1 is part of a call centre INF. In addition to the switching device VR1, the call centre INF comprises a call distribution system ACD and is additionally connected to a computer COM. This computer COM on the one hand connects a database DB to the call centre INF. On the other hand the computer COM connects the call centre INF to a data network IPN such as the Internet. Furthermore, a plurality of virtual operator workstations VAG1, VAG2, VAG3, etc. are set up at the switching device VR1 of the call centre INF.

A terminal AN for communications network subscribers is connected to the communications network KN by way of the switching device VR2. An external operator workstation OP1 is connected to the communications network KN by way of the switching device VR3. From this external operator workstation OP1, it is moreover possible to transmit operator-specific access data DAT to the computer COM by way of the data network IPN and hence to the call centre INF and the database DB. A further external operator workstation OP2 is connected to the communications network KN by way of a further switching device VR4.

If operator activity within the call centre INF is begun by an operator at the external operator workstation OP1, then in a first step 1 the operator-specific access data DAT, which contains an identification ID and a calling number RN of the external operator workstation OP1 and a password PW, is entered at the external operator workstation OP1. In a second step 2, this access data DAT is transmitted to the computer COM by way of the data network IPN. In a third step 3 the access data DAT is forwarded to the database DB by the computer COM, in order to authenticate the external operator workstation OP1. Once authentication is successful, in a fourth step 4 the identification ID and the calling number RN of the external operator workstation OP1 are stored in the database DB. In a fifth step 5, the call centre INF is interrogated to establish which of the virtual operator workstations VAG1, VAG2, VAG3, etc. which have been set up in the switching device VR1 has been designated “not reachable” for the call distribution system ACD. For example, if the virtual operator workstation VAG1 has been designated “not reachable”, then in a sixth step 6 the virtual operator workstation is linked to the external operator workstation and is designated “free” for the call distribution system ACD.

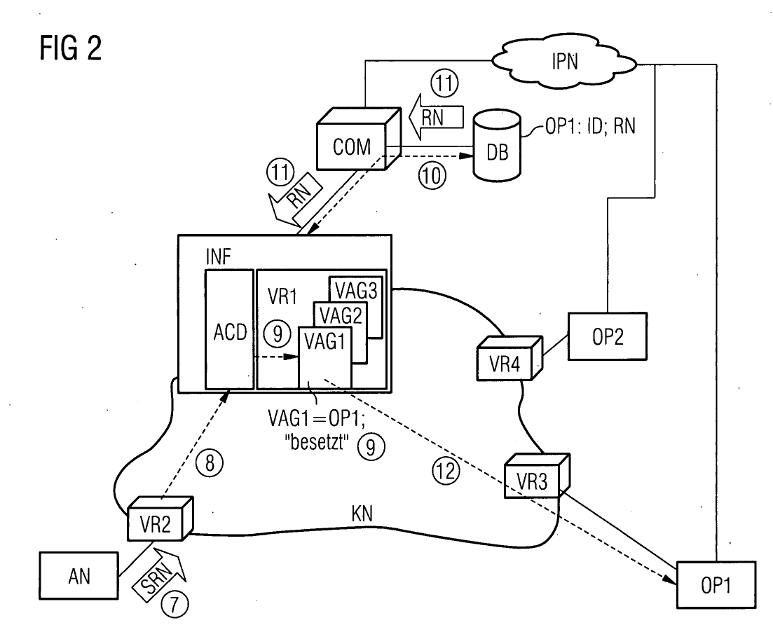

If in a seventh step 7—as is illustrated by way of example in FIG. 2—a subscriber to the communications network having the terminal AN tries to reach an operator at the call centre INF by dialling the customer service call number SRN of the call centre INF, then this call is forwarded through the communications network KN, in an eighth step 8, by way of the switching device VR2 to the switching device VR1 of the call centre INF. In a ninth step 9, this call is then dealt with by the call distribution system ACD in accordance with the criteria for distribution, with the call distribution system ACD selecting the virtual operator workstation VAG1 which is marked as “free”, for example, and marking it as “busy”. In a tenth step 10, an interrogation of the database DB by the virtual operator workstation VAG1 is started to determine the calling number RN of the external operator workstation OP1. In an eleventh step 11, the calling number RN of the external operator workstation OP1 is transmitted to the virtual operator workstation VAG1, and in a twelfth step 12 the call is forwarded by way of the switching device VR3 to the external operator workstation OP1 in order to be processed by the operator. Once the call ends, in a thirteenth step 13 the virtual operator workstation VAG1 is then designated as “free” again and can be selected for new calls by the call distribution system ACD.

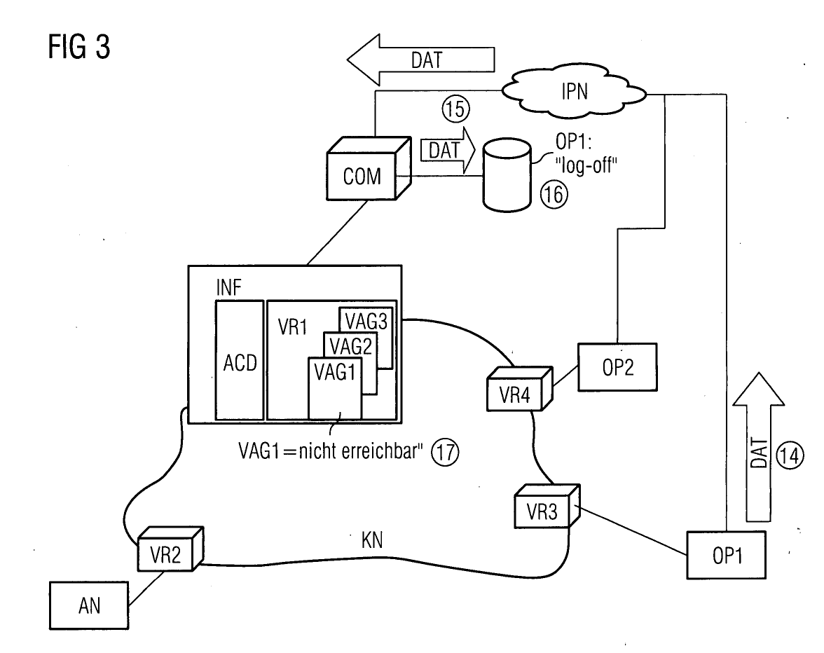

FIG. 3 shows by way of example the sequence once operator activity at the external operator workstation OP1 has ended, in which case operator-specific access data (DAT) is once again entered at the external operator workstation OP1, in a fourteenth step 14, and is transmitted to the computer COM and the database DB by way of the data network IPN. In a fifteenth step 15, the external operator workstation OP1 is then set to “log-off” in the database DB. In a sixteenth step 16, the call centre INF is once again interrogated and the link between the external operator workstation OP1 and the virtual operator workstation VAG1 is cancelled. In a seventeenth step 17, the virtual operator workstation is then designated “not reachable” for the call distribution system ACD and is thus available for links to other external operator workstations.

1-8. (canceled)

9. A call center in a communications network, comprising:
a call distribution system for distributing a call incoming to the call center; and
a virtual workstation linked to an external workstation that forwards the call to the external workstation,
wherein the virtual workstation is linked to the external workstation in response to receiving operator-specific access data for an operator of the external workstation, and
wherein the call is distributed to the external workstation via the linked virtual workstation.

10. The call center according to claim 9, wherein the operator-specific access data comprises:
an identification of the operator,
a password of the operator, and
a calling number of the external workstation.

11. The call center according to claim 10, wherein the Internet is provided for receiving the operator-specific access data.

12. The call center according to claim 10, wherein the external workstation is a mobile terminal.

13. The call center according to claim 10, wherein in the external workstation has a fixed connected to the communications network.

14. A method of operating a call center, comprising:
providing a distribution center for distributing a call incoming to the call center, the call distributed to an external workstation;
receiving a first operator-specific access data via the external workstation;
linking a virtual workstation with the external workstation;
forwarding the call to the external workstation via the virtual workstation and the call distribution system;
receiving a second operator-specific access data via the external workstation; and
releasing the link in response to receiving the second data.

15. The method according to claim 14, wherein the forwarding is handled via a call diversion.

16. The method according to claim 14, wherein the forwarding is determined dynamically.

17. A method of operating a call center, comprising:
providing a plurality of virtual workstations each having a designation selected from the group consisting of free, busy and not reachable;
providing a distribution center for distributing incoming calls to an external workstation;
receiving a first operator-specific access data via the external workstation;
linking one of the plurality of virtual workstations having a not reachable designation with the external operator workstation;
changing the designation of the linked virtual workstation from not reachable to free in response to the linking;
receiving an incoming call;
finding from the plurality of virtual workstations a virtual workstation with a free designation in response to receiving the incoming call; and
forwarding the received incoming call to the external operator workstation via the free virtual workstation

18. The method according to claim 17, further comprising changing the designation of the linked virtual workstation from to free to busy in response to the forwarding.

19. The method according to claim 18, further comprising:
receiving a second operator-specific access data via the external workstation; and
changing the designation of the linked virtual workstation from busy to not reachable in response to receiving the second data.

20. The method according to claim 17, further comprising:
receiving a second operator-specific access data via the external workstation; and
changing the designation of the linked virtual workstation from free to not reachable in response to receiving the second data.

21. The method according to claim 17, wherein the first data comprises:
an identification of the operator,
a password of the operator, and
a calling number of the external workstation.

22. The method according to claim 21, wherein a call forwarding feature is used in forwarding.

23. The method according to claim 21, further comprising storing a portion of the first data.

24. The method according to claim 23, wherein a portion of the stored data is used to forward the call to the external workstation via the virtual workstation.
